(19) United States
(12) Patent Application Publication
(10) Pub. No.: US 2015/0330593 A1
(43) Pub. Date: Nov. 19, 2015

(54) MULTIFUNCTION LIGHTGUIDE TAILIGHT ARTICLE

(71) Applicant: 3M INNOVATIVE PROPERTIES OCMPANY, Saint Paul, MN (US)

(72) Inventors: Jeremy K. Larsen, Farmington, MN (US); David A. Ender, New Richmond, WI (US); Jennifer J. Sahlin, Minneapolis, MN (US); Karl A. Vick, Elko, MN (US); Michael E. Griffin, Maplewood, MN (US); Scott M. Schnobrich, Stillwater, MN (US); Bing Hao, Woodbury, MN (US)

(73) Assignee: 3M INNOVATIVE PROPERTIES COMPANY, SAINT PAUL, MN (US)

(21) Appl. No.: 14/652,158

(22) PCT Filed: Dec. 16, 2013
(86) PCT No.: PCT/US13/75275

§ 371 Date: Jun. 15, 2015

Related U.S. Application Data
(60) Provisional application No. 61/746,722, filed on Dec. 28, 2012.

(51) Int. Cl. F21S 8/10

(52) U.S. Cl. CPC F21S 48/2243; F21S 48/215; F21S 48/2268; F21S 48/2281

(57) ABSTRACT

A taillight article (100) including a light guide (110) having an light emission front surface (112) and a rear surface (114) and a plurality of light extraction features (116) on or within the light guide (110), configured to direct light out through the emission surface (112), is described. A first light source (120) indicing a first signal function is configured to direct light in a first direction into a side surface (118) of the light guide. A second light source (130) indicating a second signal function is configured to direct light in a second direction into a second side surface (119) of the light guide, the second direction being different than the first direction.

### FIELD

The disclosure relates to taillight articles and particularly to taillight articles that include a single light guide providing multiple vehicle signal functions.

### BACKGROUND

The automotive industry has recently been adopting LED technology in tail light, head light, and other signal light applications. In some cases, a combination of LED and incandescent technology is used. In other cases, lamps use solely LEDs as sources. Tail lamps with tens or even more than a hundred LEDs are observed. In general, free-space optics have been used. Disadvantages with such an approach include the need for large cavities requiring more trunk space and the additional indirect cost associated with the generally necessary metal-working of the vehicle frame housing the lamp.

More recently, solid light guides have been proposed for the rear running light or for cosmetic purposes. In general, these solid light guides have introduced the challenges of being bulky, heavy, and not especially uniform in their light emission without the use of other optical elements such as diffusers. Such optical elements add additional complexity, cost, and reduce light brightness.

From a decorative stand-point, LEDs are point sources that are easily resolved at standard viewing distances. LEDs have been used in direct lit signal functions, however this point light source appearance may not be appealing to a viewer due to brightness, glare and other reasons. In addition, vehicle tail lamp assemblies contain multiple signal functions. Each of these signal functions has unique color, uniformity, and intensity requirements. The running light, which is operational during vehicle operation at night, is generally red or red-amber light. The stop light, which is activated intermittently, is often the same color as the running light but is generally more intense. The back-up light is generally white light and finally, the signal light, is generally either yellow, amber or red light.

### BRIEF SUMMARY

The disclosure relates to taillight articles and particularly to taillight articles that include a single light guide providing multiple vehicle signal functions.

In a first aspect of the disclosure, a taillight article includes a light guide having a light emission front surface, a rear surface, and a side surface separating the front surface and the rear surface. A plurality of light extraction features are positioned on or within the light guide. The light extraction features are configured to direct light out through the emission surface. A first light source is configured to direct light in a first direction into a side surface of the light guide. The first light source indicates a first signal function. A second light source is configured to direct light in a second direction into a second side surface of the light guide. The second light source indicates a second signal function and the second direction is different than the first direction.

In one or more embodiments, the plurality of light extraction features include a first plurality of light extraction features configured to selectively direct light, from substantially only the first light source, out through the emission surface. In one or more embodiments, the plurality of light extraction features include a second plurality of light extraction features configured to selectively direct light, from substantially only the second light source, out through the emission surface. In one or more embodiments, the light guide is an optically clear light guide. In one or more embodiments, the plurality of light extraction features is disposed on or adjacent to the rear surface of the light guide.

In one or more embodiments, the light guide is curved. In these embodiments, at least a portion of the plurality of light extraction features may be disposed on or adjacent to the front surface of the light guide.

In one or more embodiments, the first light source and the second light source are configured to direct different colored light into the edge of the light guide. In one or more embodiments, the first light source is configured to direct light in a first side surface of the light guide, and the second light source is configured to direct light in a second side surface of the light guide, the second side being different than the first side. In one or more embodiments, the light extraction features have a feature size in a range from 5 to 750 micrometers. In one or more embodiments, the first signal function and second signal function are different signal functions.

In one or more embodiments, the taillight article further includes a rear surface adjacent the light extraction rear surface. In some embodiments, the rear surface is a light reflection element and can reflect at least 70% of incident light. In one or more embodiments, the rear surface is colored. In one or more embodiments, the rear surface includes indicia or graphical elements that are observable by a viewer when at least a portion of the light guide is optically clear. In one or more embodiments, the taillight article is a laminate monolithic construction. In one or more embodiments, the taillight article has a total thickness in a range from 0.2 to 30 cm. In one or more embodiments, an adhesive is disposed on a rear surface of the taillight article, and the adhesive is configured to fix the taillight article to a vehicle. In one or more embodiments, the first signal function and second signal function are simultaneously displayed.

In one or more embodiments, the first signal function is a running light function and second signal function is a turning light function. In one or more embodiments, the first signal function is displayed in a first region of the light guide and second signal function is displayed in a second region of the light guide and the first region is not optically isolated from the second region. In one or more embodiments, the first signal function is displayed in a first region of the light guide and second signal function is displayed in a second region of the light guide and an optical isolation element separates the first region from the second region. In one or more embodiments, the plurality of light extraction features form indicia that are visible to a viewer indicating a first signal function or a second signal function.

In one or more embodiments, the taillight article further includes a third light source configured to direct light in a third direction into the light guide, the third light source indicating a third signal function and the third direction being different than the first direction and the second direction. In one or more embodiments, the taillight article further includes a direct lit light source directing light through the optically clear portion of the light guide and indicating a direct lit signal function such as a braking signal function or a back-up signal function.

In one or more embodiments, the direct lit signal function is a braking signal function or a back-up signal function and the first signal function is a running light function and second signal function is a turning light function. In one or more embodiments, the first signal function, second signal function and third signal functions are different signal functions selected from the group consisting of a running light function, a turning signal function, a braking signal function, and a back-up signal function.

In one or more embodiments, at least selected first plurality of light extraction features each define a wedge shape having a light reflection surface that direct light from the first light source out of the light guide and at least selected second plurality of light extraction features each define a wedge shape having a light reflection surface that direct light from the second light source out of the light guide. In one or more embodiments, at least selected first plurality of light extraction features each define a wedge having positive cylindrical sag or at least selected second plurality of light extraction features define a wedge having positive cylindrical sag. In one or more embodiments, at least selected first plurality of light extraction features each define a wedge having negative cylindrical sag or at least selected second plurality of light extraction features define a wedge having negative cylindrical sag. In one or more embodiments, the plurality of light extraction features has a maximum feature size in a range from 30 to 350 micrometers and an average spacing between adjacent light extraction features in a range from 125 to 725 micrometers.

In one or more embodiments, the taillight article further includes a fourth light source configured to light in a fourth direction into the light guide. The fourth light source indicates a fourth signal function and the fourth direction is different than the first direction, the second direction, and the third direction. In one or more embodiments the first light source, second light source, third light source and fourth light source all inject light into the edge of the light guide. In one or more embodiments the first signal function, second signal function, third signal function, and fourth signal function are different signal functions selected from the group consisting of a running light function, a turning signal function, a braking signal function, and a back-up signal function.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

The disclosure may be more completely understood in consideration of the following detailed description of various embodiments of the disclosure in connection with the accompanying drawings, in which:

FIG. 1 is a schematic perspective view of an vehicle with illustrative taillights;

FIG. 2 is a schematic cross-sectional view of an illustrative taillight;

FIG. 3 is a schematic front view of an illustrative taillight;

FIG. 4 is a schematic front view of another illustrative taillight;

FIG. 5 is a schematic front interior view of the illustrative taillight of FIG. 4;

FIG. 6 is a schematic front interior view of another source light configuration for the illustrative taillight of FIG. 4;

FIG. 7 is a schematic perspective view of an illustrative light extraction feature; and

FIG. 8 is a schematic perspective view of another illustrative light extraction feature.

### DETAILED DESCRIPTION

In the following detailed description, reference is made to the accompanying drawings that form a part hereof, and in which are shown by way of illustration several specific embodiments. It is to be understood that other embodiments are contemplated and may be made without departing from the scope or spirit of the present disclosure. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above those other elements.

As used herein, when an element, component or layer for example is described as forming a “coincident interface” with, or being “on” “connected to,” “coupled with” or “in contact with” another element, component or layer, it can be directly on, directly connected to, directly coupled with, in direct contact with, or intervening elements, components or layers may be on, connected, coupled or in contact with the particular element, component or layer, for example. When an element, component or layer for example is referred to as being “directly on,” “directly connected to,” “directly coupled with,” or “directly in contact with” another element, there are no intervening elements, components or layers for example.

As used herein, “have”, “having”, “include”, “including”, “comprise”, “comprising” or the like are used in their open ended sense, and generally mean “including, but not limited to.” It will be understood that the terms “consisting of” and “consisting essentially of” are subsumed in the term “comprising,” and the like.

The term “optically clear” refers to an element being transparent to a viewer so that a viewer can easily discern what the optically clear element is separating from the viewer. Visible light can transmit through an optically clear element. In many embodiments, an optically clear element is colorless such as clear glass. Extractors or extraction features may be present in an optically clear region, but their density and size are small enough to enable optical clarity, as described below.

The term “signal function” refers to a light indication of a running light indication, a braking light indication, a back-up light or a turning light indication.

The disclosure relates to taillight articles and particularly to taillight articles that include a single light guide providing multiple vehicle signal functions, among other aspects. This taillight article selectively extracts light from two or more light sources to allow for two or more vehicle signal functions with a single light guide. While the present disclosure is not so limited, an appreciation of various aspects of the disclosure will be gained through a discussion of the examples provided below.

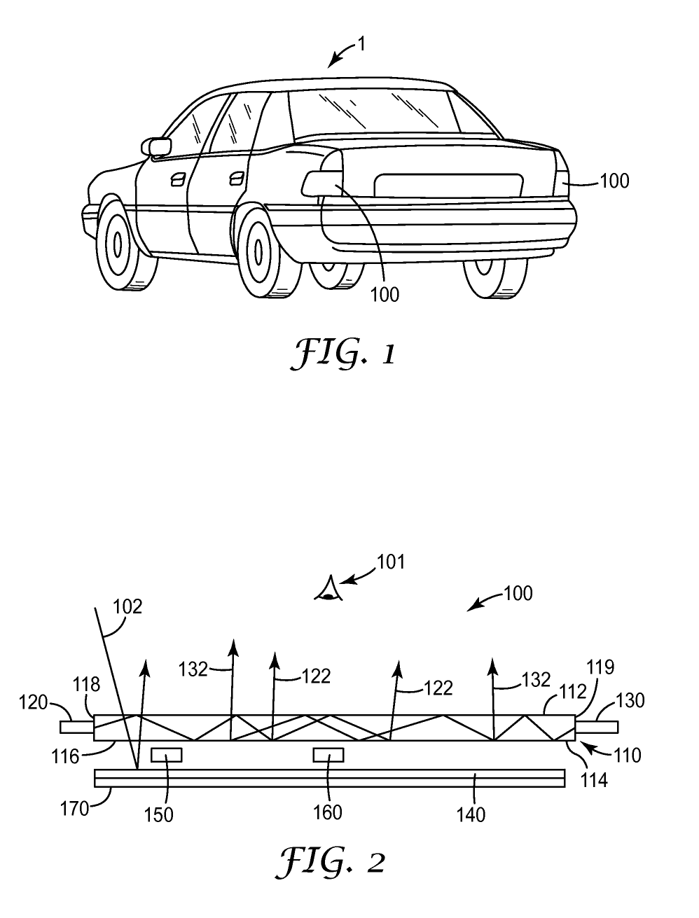

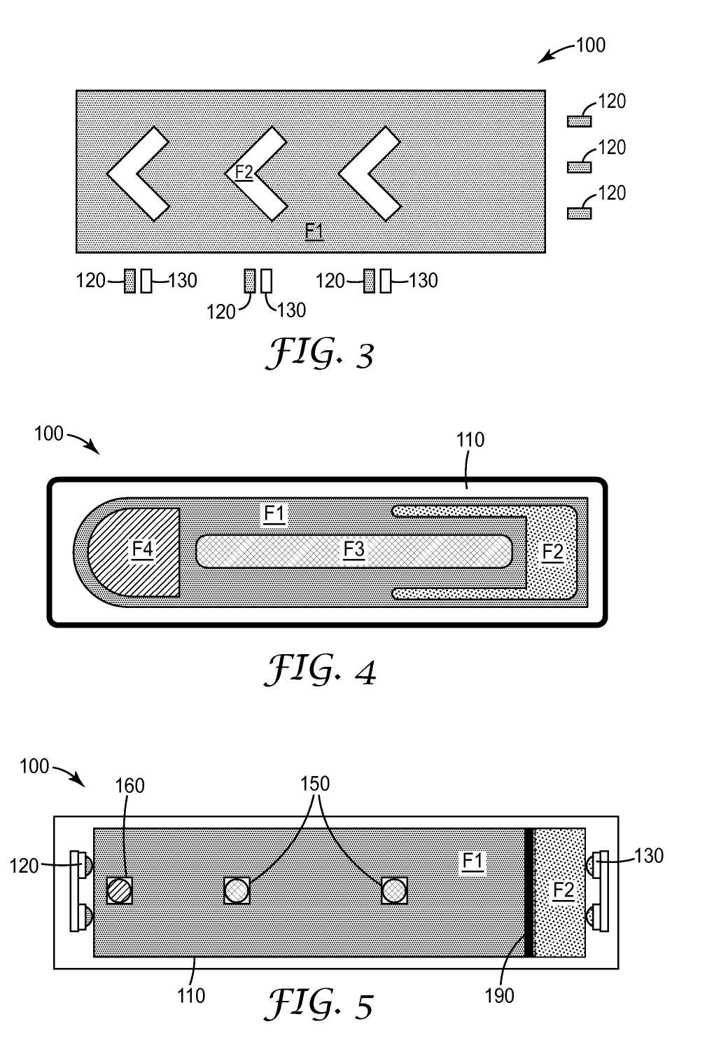

FIG. 1 is a schematic perspective view of a vehicle 1 with illustrative taillights 100. FIG. 2 is a schematic cross-sectional view of an illustrative taillight 100. FIG. 3 is a schematic front view of an illustrative taillight 100. While the taillight article 100 is illustrated as a rectangular element on the rear of a vehicle 1, it is understood that the taillight article 100 can have any useful shape and be placed in any useful location on a vehicle. For example, in the case of a curved taillight, the taillight may curve around the back corners of the vehicle, such that a portion of the taillight is co-planar or near co-planar with the back of the car, and a portion of the taillight is co-planar or near co-planar with the side of the car. While the taillight article 100 is illustrated as being generally rectangular in shape, it is understood that the taillight article 100 can have any useful shape.

In one or more embodiments, a taillight article 100 includes a light guide 110 having a light emission front surface 112 and a rear surface 114 and a side surface 118 separating the front surface 112 and the rear surface 114. A plurality of light extraction features 116 are on or within the light guide 110. The light extraction features 116 are configured to direct light out through the emission surface 112. While the light guide 110 is illustrated as being generally rectangular in shape, it is understood that the light guide 110 can have any useful perimeter shape such as a curvilinear or curved shape. In these embodiments, a side surface is understood as being a region along the edge surface of the curved light guide 110.

A first light source 120 is configured to direct light in a first direction into a side surface 118 of the light guide 110 and this light leaves the light guide 110 as emitted light 122. The first light source 120 indicates a first signal function F1. A second light source 130 is configured to direct light in a second direction into a second side surface 119 of the light guide 110 and this light leaves the light guide 110 as emitted light 132. The second light source 130 indicates a second signal function F2 and the second direction is different than the first direction. In one or more embodiments, the first signal function F1 and second signal function F2 are different signal functions. The term “light source” refers to a single point source and a plurality of light sources.

In one or more embodiments, the first signal function F1 is a running light function and second signal function F2 is a turning light function. In one or more embodiments, the first signal function F1 is displayed in a first region of the light guide 110 and second signal function F2 is displayed in a second region of the light guide 110. In one or more embodiments, the plurality of light extraction features 116 form indicia that are visible to a viewer indicating a first signal function F1 or a second signal function F2. In many embodiments, the first signal function F1 or a second signal function F2 are displayed simultaneously as illustrated in FIG. 3.

In one or more embodiments, the plurality of light extraction features 116 form indicia that are visible to a viewer indicating a decorative or aesthetic function such as displaying a logo or other graphical element. While the figures illustrate two or more light sources (defined by one or more point light sources such as LEDs) where each light source edge lights a single “side” of the light guide 110, it is contemplated that two or more light sources (defined by one or more point light sources such as LEDs) can be disposed along a single side of the light guide 110 where each light source can illuminate a particular region, zone or area of the light guide 110. In addition, two or more plurality of light extraction features can be independently orientated to selectively reflect light from a specific light source (edge lighting the light guide 110) out of the light guide 110 in a same region, zone or area of the light guide 110.

In one or more embodiments, the plurality of light extraction features 116 include a first plurality of light extraction features configured to selectively direct light 122, from substantially only the first light source 120, out through the emission surface 112. In one or more embodiments, the plurality of light extraction features 116 include a second plurality of light extraction features configured to selectively direct light 132, from substantially only the second light source 130, out through the emission surface 112.

In one or more embodiments, the light guide 110 is an optically clear light guide. In one or more embodiments, the plurality of light extraction features 116 are disposed on or adjacent to the rear surface 114 of the light guide 110. In one or more embodiments, the light guide 110 is curved. In some of these embodiments, at least a portion of the plurality of light extraction features 116 are disposed on or adjacent to the front surface 112 of the light guide 110.

In one or more embodiments, the first light source 120 and the second light source 130 are configured to direct different colored light into the light guide 110. In one or more embodiments, the first light source 120 is configured to direct light 122 in a first side surface 118 of the light guide 110, and the second light source 130 is configured to direct light 132 in a second side surface 119 of the light guide 110, the second side being different than the first side. In other embodiments, the second side and the first side are the same side. In embodiments where the light guide 110 defines a curved perimeter, the first side and the second side are different portions of the edge of the light guide 110.

The first light source 120 can be any useful light source and can be one or a plurality of light sources emitting in the first direction. In one or more embodiments, the first light source 120 is a solid state light source such as a light emitting diode (LED), for example. The second light source 130 can be any useful light source and can be one or a plurality of light sources emitting light in the second direction. In one or more embodiments, the second light source 130 is a solid state light source such as a light emitting diode (LED), for example.

FIG. 7 is a schematic perspective view of an illustrative light extraction feature 116. FIG. 8 is a schematic perspective view of another illustrative light extraction feature 116. The extraction features 116 can have any useful shape that will direct light out of the light guide 110. In one or more embodiments the extraction features 116 are generally not discernible under observation from a viewer 101. In many embodiments the extraction features 116 are patterned to provide uniform illumination along an entire lateral dimension of the light guide 110 from the first light source 120 and/or second light source 130 or additional third and fourth light sources, as desired. In some embodiments, the light extraction features 116 form a pattern that illuminates indicia or a graphical element that is observable by a viewer. In some embodiments, the light extraction features 116 define an illuminated region that forms indicia or graphical elements that are observable by a viewer. These illuminated indicia or graphical elements can be selectively illuminated with either light from the first light source 120 or second light source 130 as illustrated in FIG. 3. In one or more embodiments, the first signal function F1 and second signal function F2 are simultaneously displayed as illustrated in FIG. 3. In one or more embodiments, the first portions of signal function F2 and second portions of signal function F2 and third portions of signal function F2 are sequentially displayed.

For purposes of this description, where a direction corresponds to a provided axis of a coordinate system (see FIG. 7 and FIG. 8), for example the y-axis, it may be referred to as, e.g., “the y-direction.” The z-direction is perpendicular to the x-direction along which the light guide emission surface extends. The y-direction is perpendicular to the x-direction and z-direction and extends in an out-of-plane direction from the light guide emission surface.

In order to direct signal function light along the y-direction that is initially generally propagated along the z-direction, it is necessary to appropriately choose proper light extraction element shapes, orientation, and potentially spacing. A number of different shapes of light extraction elements are contemplated in the present description, for example, the light extraction features may be prisms, cones, aspheric cones, truncated prisms, cones, aspheric cones, wedges, hemispheres, conic sections, or truncated conic sections. A further description of these shapes and other appropriate light extraction features, as well as potential method of making such shapes may be found in commonly owned U.S. Pat. No. 7,941,013 (Martilla et al.), the relevant portions of which are hereby incorporated by reference. A method of forming the appropriate light extraction features is also described in commonly owned U.S. Patent Application Publication No. 2012/0126038 (Carpenter et al.), the relevant portions of which are hereby incorporated by reference.

In one or more embodiments, the light extraction features may be wedges, as illustrated in FIG. 7 and FIG. 8. The wedge shown in FIG. 7 is a wedge having negative cylindrical sag. The wedge shown in FIG. 8 is a wedge having positive cylindrical sag. Both of these shapes are contemplated as appropriate light extractor shapes in the present description. These light extraction features project into the solid light guide.

It is also important to properly orient the light extraction feature with respect to the incident light from the appropriate light source. This provides the selective extraction of light, minimizing functional cross-talk between regions desired in the present description. A facet or light reflection face 216 faces the first light source 120, for example, (along a z-direction for example) and reflects signal function light 122 emitted from the first light source 120 along a y-direction (for example) and out of the optically clear light guide 110. Light that is incident on a side surface 218, or any surface other than the facet or light reflection face 216 will not substantially reflect light 122 in the y-direction and direct light 122 out of the optically clear light guide 110.

In many of these embodiments, the light guide 110 that include these light extraction features is considered to be optically clear. Visible light 102 can transmit through the optically clear (or optically clear portion of the) light guide 110 so that a viewer 101 can discern what is behind optically clear portions of the light guide 110 of the taillight article 100. In one or more embodiments indicia or graphical elements can be disposed behind optically clear portions of the light guide 110 of the taillight article 100. The visible light 102 can transmit through the optically clear light guide 110 from the external environment and reflect off the indicia or graphical elements and return back to a viewer 101 such that a viewer 101 can observe the indicia or graphical elements behind optically clear portions of the light guide 110 of the taillight article 100. Indicia or graphical elements can be any useful indicia or graphical elements that may provide a structured, faceted or jewel-like appearance, for example. In some embodiments, the indicia may be a brand or model name for a vehicle.

In one or more embodiments, the light extraction features 116 have a feature size (e.g., largest lateral dimension) in a range from 5 to 750 micrometers or from 30 to 600 micrometers. In some embodiments, the light extraction features increase in size as a distance from the light source increases. In general, the extraction efficiency should increase as distance from the light source increases to maintain uniform extraction across the top surface of the light guide. In some embodiments, the light extraction features increase in size as a distance from the light source increases. In some embodiments, extractor efficiency is increased by orientation, positioning, or increasing the density of the light extraction features, or other means.

Proper sizing and spacing of light extraction features provides an “optically clear” appearance. In one or more embodiments, the light extraction features have a feature size (i.e., largest lateral dimension) in a range from 5 to 600 micrometers and an average spacing (ie., minimum lateral distance) in a range from 125 to 725 micrometers, where smaller light extraction features may be spaced further from one another than larger light extraction features. In one or more embodiments, the light extraction features have a feature size (i.e., largest lateral dimension) in a range from 20 to 450 micrometers and an average spacing (ie., minimum lateral distance) in a range from 125 to 725 micrometers. In one or more embodiments the light extraction features have a feature size (i.e., largest lateral dimension) in a range from 30 to 350 micrometers and an average spacing (ie., minimum lateral distance) in a range from 125 to 725 micrometers. In some embodiments, a portion of the light extraction features may be visible to a viewer 101 and can have a size in a range from 3000 to 6000 micrometers.

In one or more embodiments, the taillight article 100 further includes a rear surface 140 adjacent the light extraction rear surface 114. In some embodiments, the rear surface 140 is a light reflection element and can reflect at least 70% of incident light. In one or more embodiments, the rear surface 140 is colored. In one or more embodiments, the rear surface 140 includes indicia or a graphical element that is observable by a viewer when at least a portion of the light guide 110 is optically clear.

The taillight article can have any useful thickness. One illustrative advantage of the taillight articles 100 described herein is the thin form factor for fixing the taillight article onto a vehicle. In one or more embodiments, the taillight article 100 is a laminate monolithic construction with a low index layer between the reflective surface 140 and the light guide 110. In one or more embodiments, the taillight article 110 has a total thickness in a range from 0.2 to 30 mm or from 0.2 to 20 mm or from 2 to 10 mm. In one or more embodiments, an adhesive 170 is disposed on a rear surface 140 of the taillight article 100. The adhesive 170 is configured to fix the taillight article 100 to a vehicle 1. In many embodiments the adhesive 170 is a pressure sensitive adhesive.

A light reflection element 140 or rear surface can be spaced apart from the rear surface 114 of the light guide 110 and define an air space having a thickness in a range from 1 to 50 mm or from 1 to 30 mm or from 1 to 20 mm.

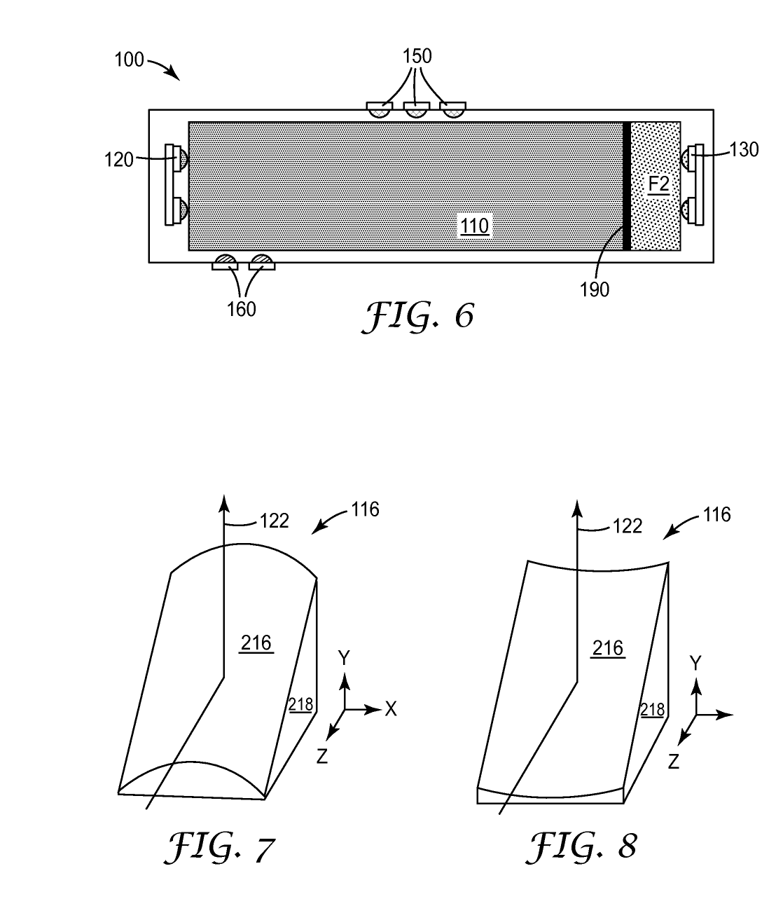

FIG. 4 is a schematic front view of another illustrative taillight 100. FIG. 5 is a schematic front interior view of the illustrative taillight 100 of FIG. 4, where the light guide 110 is optically clear or transparent. FIG. 6 is a schematic front interior view of another source light configuration for the illustrative taillight 100 of FIG. 4, where the four light sources all edge light the light guide 110.

In one or more embodiments, the first signal function F1 is displayed in a first region of the light guide 110 and second signal function F2 is displayed in a second region of the light guide 110 and an optical isolation element 190 separates the first region from the second region, as illustrated in FIG. 5. The optical isolation element 190 can be molded into the light guide 110, as desired.

In one or more embodiments, the taillight article 100 further includes a third light source 150 configured to direct light in a third direction into the light guide 110, as illustrated in FIG. 5. The third light source 150 indicates a third signal function F3 and the third direction is different than the first direction and the second direction. In one or more embodiments, the taillight article 100 further includes a fourth light source 160 directing light through the light guide 110 and indicating a fourth direct lit signal function F4 being a braking signal function or a back-up signal function. In some embodiments, the third light source 150 includes a direct lit light source 150 directing light through the light guide 110 and indicating a direct lit signal function F3 being a braking (i.e., stop) signal function or a back-up signal function. In one or more of these embodiments, the taillight article with a direct lit function has a total thickness in a range from 0.2 to 30 cm.

In one or more embodiments, the taillight article 100 further includes a third light source 150 configured to edge light in a third direction into the light guide 110, as illustrated in FIG. 6. The third light source 150 indicates a third signal function F3 and the third direction is different than the first direction and the second direction. In one or more embodiments the taillight article 100 further includes a fourth light source 160 configured to edge light in a fourth direction into the light guide 110 and indicating a fourth signal function F4 being a braking signal function or a back-up signal function. In these edge lit only embodiments the thickness T of the taillight article 100 is substantially reduced. In one or more of these embodiments, the taillight article has a total thickness in a range from 0.2 to 30 mm.

Regions F2, F3, and F4 mean different things for FIG. 5 and FIG. 6. For FIGS. 5, F2, F3, and F4 could be the same optically clear extractor pattern as F1, with the regions defined by the indirect optics associated with the sources 150 and 160. For FIG. 6, they mean regions with extractors or extractor features facing in different directions, toward the respective LEDs 150 and 160.

In one or more embodiments the fourth signal function F4 is a braking signal function or a back-up signal function and the first signal function F1 is a running light function and second signal function F2 is a turning light function. In one or more embodiments the first signal function F1, second signal function F2, third signal functions F3 and fourth signal function F4 are different signal functions selected from the group consisting of a running light function, a turning signal function, a braking signal function, and a back-up signal function.

As illustrated in FIG. 4, the taillight article 100 can display all four taillight functions in separate areas of the light guide 110. The first signal function F1 is a running light function and second signal function F2 is a turning light function and both of these functions are provided with edge lighting of the light guide 110 and using selective extractors 116 and/or isolation elements 190. The taillight article 100 further displays a third signal function F3 and fourth signal function that are both direct lit light sources transmitting light through the light guide and being a braking signal function, and a back-up signal function.

The following is a list of items of the present disclosure:

Item 1 is a taillight article comprising:
a light guide having an light emission front surface and a rear surface and a side surface separating the front surface and the rear surface, and a plurality of light extraction features on or within the light guide, the light extraction features configured to direct light out through the emission surface;
a first light source configured to direct light in a first direction into a side surface of the light guide, the first light source indicating a first signal function;
a second light source configured to direct light in a second direction into a second side surface of the light guide, the second light source indicating a second signal function and the second direction being different than the first direction.

Item 2 is a taillight article according to item 1, wherein the plurality of light extraction features comprises a first plurality of light extraction features configured to selectively direct light, from substantially only the first light source, out through the emission surface.

Item 3 is a taillight article according to any of the preceding items, wherein the plurality of light extraction features comprises a second plurality of light extraction features configured to selectively direct light, from substantially only the second light source, out through the emission surface.

Item 4 is a taillight article according to any of the preceding items, wherein at least a portion of the light guide is optically clear.

Item 5 is a taillight article according to any of the preceding items, wherein the plurality of light extraction features are disposed on or adjacent to the rear surface of the light guide.

Item 6 is a taillight article according to any of the preceding items, wherein the light guide is curved.

Item 7 is a taillight article according to item 6, wherein a portion of the plurality of light extraction features is disposed on or adjacent to the front surface of the light guide.

Item 8 is a taillight article according to any of the preceding items, wherein the first light source and the second light source are configured to direct different colored light into the of the light guide.

Item 9 is a taillight article according to any of the preceding items, wherein the first light source is configured to direct light in a first side surface of the light guide, and the second light source is configured to direct light in a second side surface of the light guide, the second side being different than the first side.

Item 10 is a taillight article according to any of the preceding items, wherein the first light guide light extraction features have a feature size in a range from 5 to 750 micrometers.

Item 11 is a taillight article according to any of the preceding items, wherein the first signal function and second signal function are different signal functions.

Item 12 is a taillight article according to any of the preceding items, further comprising a rear surface of the taillight article adjacent the light guide rear surface and the rear surface of the taillight article is a light reflection element reflecting at least 70% of incident light.

Item 13 is a taillight article according to any of the preceding items, further comprising a rear surface of the taillight article adjacent the light guide rear surface, wherein the rear surface of the taillight article is colored.

Item 14 is a taillight article according to any of items 12 to 13, wherein the light reflection element or the rear surface of the taillight article comprise indicia or a graphical element that are observable by a viewer.

Item 15 is a taillight article according to any of the preceding items, wherein the taillight article is a laminate monolithic construction.

Item 16 is a taillight article according to any of the preceding items, wherein the taillight article has a total thickness in a range from 0.2 to 30 mm.

Item 17 is a taillight article according to any of the preceding items, wherein an adhesive is disposed on a rear surface of the taillight article, the adhesive being configured to fix the taillight article to a vehicle.

Item 18 is a taillight article according to any of the preceding items, wherein the first signal function and second signal function are simultaneously displayed.

Item 19 is a taillight article according to any of the preceding items, wherein the first signal function is a running light function and second signal function is a turning light function.

Item 20 is a taillight article according to any of the preceding items, wherein the first signal function is displayed in a first region of the light guide and second signal function is displayed in a second region of the light guide, and the first region is not optically isolated from the second region.

Item 21 is a taillight article according to item 1 to 19, wherein the first signal function is displayed in a first region of the light guide and second signal function is displayed in a second region of the light guide, and an optical isolation element separates the first region from the second region.

Item 22 is a taillight article according to any of the preceding items, wherein the plurality of light extraction features form indicia that are visible to a viewer indicating a first signal function or a second signal function.

Item 23 is a taillight article according to any of the preceding items, further comprising a third light source configured to direct light in a third direction into the light guide, the third light source indicating a third signal function and the third direction being different than the first direction and the second direction.

Item 24 is a taillight article according to any of the preceding items, further comprising a direct lit light source directing light through the light guide and indicating a direct lit signal function being a braking signal function or a back-up signal function.

Item 25 is a taillight article according to item 24, wherein the direct lit signal function is a braking signal function or a back-up signal function and the first signal function is a running light function and second signal function is a turning light function.

Item 26 is a taillight article according to any of the preceding items, wherein the first signal function, second signal function and third signal functions are different signal functions selected from the group consisting of a running light function, a turning signal function, a braking signal function, and a back-up signal function.

Item 27 is a taillight article according to any of the preceding items, comprising at least a selected first plurality of light extraction features in which each extraction feature is defined as a wedge shape having a light reflection surface that directs light from the first light source out of the light guide and at least a selected second plurality of light extraction features in which each extraction feature is defined as a wedge shape having a light reflection surface that direct light from the second light source out of the light guide.

Item 28 is a taillight article according to item 27, comprising at least a selected first plurality of light extraction features in which each extraction feature is defined as a wedge having positive cylindrical sag or at least a selected second plurality of light extraction features in which each extraction feature is defined as a wedge having positive cylindrical sag.

Item 29 is a taillight article according to item 27, wherein at least a selected first plurality of light extraction features each define a wedge having negative cylindrical sag or at least a selected second plurality of light extraction features define a wedge having a negative cylindrical sag.

Item 30 is a taillight article according to item 4, wherein the plurality of light extraction features have a maximum feature size in a range from 30 to 350 micrometers and an average spacing between adjacent light extraction features in a range from 125 to 725 micrometers.

Item 31 is a taillight article according to any of the preceding items, further comprising a fourth light source configured to light in a fourth direction into the light guide, the fourth light source indicating a fourth signal function and the fourth direction being different than the first direction, the second direction, and the third direction.

Item 32 is a taillight article according to item 31, wherein the first light source, second light source, third light source and fourth light source all inject light into an edge of the light guide.

Item 33 is a taillight article according to items 31 or 32, wherein the first signal function, second signal function, third signal function, and fourth signal function are different signal functions selected from the group consisting of a running light function, a turning signal function, a braking signal function, and a back-up signal function.

Item 34 is a taillight article according to any of the preceding items, wherein the taillight article has a total thickness in a range from 0.2 to 30 cm.

Item 35 is a taillight article according to items 32 or 33, wherein the taillight article has a total thickness in a range from 0.2 to 30 mm.

Item 36 is a taillight article according to item 19, wherein the turning light function comprises multiple regions along the lightguide that are sequentially illuminated.

Embodiments of the present disclosure are disclosed. The disclosed embodiments are presented for purposes of illustration and not limitation. The implementations described above and other implementations are within the scope of the following claims. One skilled in the art will appreciate that the present disclosure can be practiced with embodiments other than those disclosed. Those having skill in the art will appreciate that many changes may be made to the details of the above-described embodiments and implementations without departing from the underlying principles thereof. Further, various modifications and alterations of the present invention will become apparent to those skilled in the art without departing from the spirit and scope of the present disclosure. The scope of the present application should, therefore, be determined only by the following claims.

1. A taillight article comprising:
a light guide having an light emission front surface and a rear surface and a side surface separating the front surface and the rear surface, and a plurality of light extraction features on or within the light guide, the light extraction features configured to direct light out through the emission surface;
a first light source configured to direct light in a first direction into a side surface of the light guide, the first light source indicating a first signal function;
a second light source configured to direct light in a second direction into a second side surface of the light guide, the second light source indicating a second signal function and the second direction being different than the first direction.

2. A taillight article according to claim 1, wherein the plurality of light extraction features comprises a first plurality of light extraction features configured to selectively direct light, from substantially only the first light source, out through the emission surface.

3. A taillight article according to claim 1, wherein the plurality of light extraction features comprises a second plurality of light extraction features configured to selectively direct light, from substantially only the second light source, out through the emission surface.

4-10. (canceled)

11. A taillight article according to claim 1, wherein at least a portion of the light guide is optically clear.

12. A taillight article according to claim 1, wherein the plurality of light extraction features are disposed on or adjacent to the rear surface of the light guide.

13. A taillight article according to claim 1, wherein the light guide is curved.

14. A taillight article according to claim 13, wherein a portion of the plurality of light extraction features is disposed on or adjacent to the front surface of the light guide.

15. A taillight article according to claim 1, wherein the first light source and the second light source are configured to direct different colored light into the of the light guide.

16. A taillight article according to claim 1, wherein the first light source is configured to direct light in a first side surface of the light guide, and the second light source is configured to direct light in a second side surface of the light guide, the second side being different than the first side.

17. A taillight article according to claim 1, wherein the first light guide light extraction features have a feature size in a range from 5 to 750 micrometers.

18. A taillight article according to claim 1, wherein the first signal function and second signal function are different signal functions.

19. A taillight article according to claim 1, further comprising a rear surface of the taillight article adjacent the light guide rear surface and the rear surface of the taillight article is a light reflection element reflecting at least 70% of incident light.

20. A taillight article according to claim 1, further comprising a rear surface of the taillight article adjacent the light guide rear surface, wherein the rear surface of the taillight article is colored.

21. A taillight article according to claim 19, wherein the light reflection element or the rear surface of the taillight article comprise indicia or a graphical element that are observable by a viewer.

22. A taillight article according to claim 1, wherein the taillight article is a laminate monolithic construction.

23. A taillight article according to claim 1, wherein the taillight article has a total thickness in a range from 0.2 to 30 mm.

24. A taillight article according to claim 1, wherein an adhesive is disposed on a rear surface of the taillight article, the adhesive being configured to fix the taillight article to a vehicle.

25. A taillight article according to claim 1, wherein the first signal function and second signal function are simultaneously displayed.

26. A taillight article according to claim 1, wherein the first signal function is a running light function and second signal function is a turning light function.

27. A taillight article according to claim 1, wherein the first signal function is displayed in a first region of the light guide and second signal function is displayed in a second region of the light guide, and the first region is not optically isolated from the second region.

28. A taillight article according to claim 1, wherein the first signal function is displayed in a first region of the light guide and second signal function is displayed in a second region of the light guide, and an optical isolation element separates the first region from the second region.

29. A taillight article according to claim 1, wherein the plurality of light extraction features form indicia that are visible to a viewer indicating a first signal function or a second signal function.

30. A taillight article according to claim 1, further comprising a third light source configured to direct light in a third direction into the light guide, the third light source indicating a third signal function and the third direction being different than the first direction and the second direction.

31. A taillight article according to claim 1, further comprising a direct lit light source directing light through the light guide and indicating a direct lit signal function being a braking signal function or a back-up signal function.

32. A taillight article according to claim 31, wherein the direct lit signal function is a braking signal function or a back-up signal function and the first signal function is a running light function and second signal function is a turning light function.

33. A taillight article according to claim 1, wherein the first signal function, second signal function and third signal functions are different signal functions selected from the group consisting of a running light function, a turning signal function, a braking signal function, and a back-up signal function.

34. A taillight article according to claim 1, comprising at least a selected first plurality of light extraction features in which each extraction feature is defined as a wedge shape having a light reflection surface that directs light from the first light source out of the light guide and at least a selected second plurality of light extraction features in which each extraction feature is defined as a wedge shape having a light reflection surface that direct light from the second light source out of the light guide.

35. A taillight article according to claim 34, comprising at least a selected first plurality of light extraction features in which each extraction feature is defined as a wedge having positive cylindrical sag or at least a selected second plurality of light extraction features in which each extraction feature is defined as a wedge having positive cylindrical sag.

36. A taillight article according to claim 34, wherein at least a selected first plurality of light extraction features each define a wedge having negative cylindrical sag or at least a selected second plurality of light extraction features define a wedge having a negative cylindrical sag.

37. A taillight article according to claim 11, wherein the plurality of light extraction features have a maximum feature size in a range from 30 to 350 micrometers and an average spacing between adjacent light extraction features in a range from 125 to 725 micrometers.

38. A taillight article according to claim 1, further comprising a fourth light source configured to light in a fourth direction into the light guide, the fourth light source indicating a fourth signal function and the fourth direction being different than the first direction, the second direction, and the third direction.

39. A taillight article according to claim 38, wherein the first light source, second light source, third light source and fourth light source all inject light into an edge of the light guide.

40. A taillight article according to claim 38, wherein the first signal function, second signal function, third signal function, and fourth signal function are different signal functions selected from the group consisting of a running light function, a turning signal function, a braking signal function, and a back-up signal function.

41. A taillight article according to claim 1, wherein the taillight article has a total thickness in a range from 0.2 to 30 cm.

42. A taillight article according to claim 39, wherein the taillight article has a total thickness in a range from 0.2 to 30 mm.

43. A taillight article according to claim 26, wherein the turning light function comprises multiple regions along the lightguide that are sequentially illuminated.
